(19) United States
(12) Patent Application Publication
(10) Pub. No.: US 2010/0052416 A1
(43) Pub. Date: Mar. 4, 2010

(54) SYNCHRONIZING BRAKE DEVICE FOR VEHICLE

(76) Inventors: Manabu Aiba, Saitama (JP); Odai Uchida, Saitama (JP); Atsuhiko Shinohara, Saitama (JP)

Correspondence Address: BIRCH STEWART KOLASCH & BIRCH, PO BOX 747, FALLS CHURCH, VA, 22040-0747, US

(21) Appl. No.: 12/546,316

(22) Filed: Aug. 24, 2009

(30) Foreign Application Priority Data
Aug. 29, 2008 (JP) 2008-222886
Mar. 31, 2009 (JP) 2009-085048

(51) Int. Cl. B60T 8/00

(52) U.S. Cl. 303/35

(57) ABSTRACT

A synchronizing brake device for a vehicle is provided with a first brake, a second brake, a synchronizing brake operating lever that synchronizes and operates the first and second brakes, an equalizer that distributes the control force of the synchronizing brake operating lever to the first brake and the second brake, a hydraulic master cylinder that generates hydraulic pressure for operating the first brake and first brake control force transmitting member which transmits control force from the equalizer to the hydraulic master cylinder and which is configured by a synchronizing member operated by the equalizer and a knocker that presses the hydraulic master cylinder by the operation of the synchronizing member. The knocker is provided with a knocker operating lever that can press the hydraulic master cylinder by being directly operated without depending upon the synchronizing member.

### CROSS-REFERENCE TO RELATED APPLICATIONS

The present application claims priority under 35 USC 119 to Japanese Patent Application No. 2008-222886 filed on Aug. 29, 2008 and Japanese Patent Application No. 2009-085048 filed on Mar. 31, 2009 the entire contents of which are hereby incorporated by reference.

### BACKGROUND OF THE INVENTION

1. Field of the Invention

The present invention relates to a synchronizing brake device for a vehicle that synchronizes and operates a hydraulic brake and a mechanical brake. More particularly, to the air bleeding of a hydraulic master cylinder used for the synchronizing brake device for a vehicle.

2. Description of Background Art

For a synchronizing brake device for a vehicle is known that operates a hydraulic disc brake and a mechanical drum brake with either of two brake operating levers and operates the hydraulic disc brake with the other.

This type of synchronizing brake device for a vehicle uses a master cylinder unit wherein the hydraulic disc brake and the mechanical drum brake can be selectively operated, for example, a hydraulic master cylinder and a lever mechanism are combined.

A synchronizing brake device for a vehicle is known wherein a hydraulic brake and a mechanical brake are synchronized using the same hydraulic master cylinder. See, for example, JP-A No. 2002-220077.

The synchronizing brake device for a vehicle disclosed in JP-A No. 2002-220077 is a synchronizing brake device for a vehicle where only a hydraulic brake is operated with a first brake lever (a right lever) and the hydraulic brake and a mechanical brake are operated with a second brake lever (a left lever). When the hydraulic brake is operated with the first brake lever and when the hydraulic brake and the mechanical brake are operated with the second brake lever, the same master cylinder is also used.

In such a synchronizing brake device for a vehicle, air bleeding in a hydraulic circuit including the master cylinder can be executed by operating the first brake lever.

For example, when a first master cylinder dedicated to the hydraulic brake is provided to the first brake lever and a master cylinder unit for operating the hydraulic brake and the mechanical brake with the second brake lever is adopted, the air bleeding of a second master cylinder to be a component of the master cylinder unit is executed by the second brake lever.

However, as the second brake lever is a lever for operating the hydraulic brake and the mechanical brake, the mechanical brake is also operated in air bleeding. Therefore, there is a problem wherein most of a manipulated variable and the operation force of the second brake lever is used for the operation of the mechanical brake and the motion of a delay spring which is a component of the master cylinder unit and others and it takes a long time for the air bleeding of the hydraulic master cylinder of the master cylinder unit.

### SUMMARY AND OBJECTS OF THE INVENTION

An object of an embodiment of the present invention is to provide a synchronizing brake device for a vehicle wherein the air bleeding of a hydraulic master cylinder to be a component of a master cylinder unit can be easily executed and work time for air bleeding can be reduced.

According to an embodiment of the present invention, a synchronizing brake device for a vehicle is provided with a first brake, a second brake, a synchronizing brake operating lever that synchronizes and operates the first brake and the second brake, an equalizer that distributes the control force of the synchronizing brake operating lever to the first brake and the second brake, a hydraulic master cylinder that generates hydraulic pressure for operating the first brake and first brake control force transmitting means which transmits a control force from the equalizer to the hydraulic master cylinder and which is configured by a synchronizing member operated by the equalizer and a knocker that presses the hydraulic master cylinder by the operation of the synchronizing member. The knocker is provided with a knocker operating lever that can press the hydraulic master cylinder by being directly operated without depending upon the synchronizing member.

According to an embodiment of the present invention, the knocker is provided with a socket for a tool.

According to an embodiment of the present invention, the knocker presses the hydraulic master cylinder by being turned and the socket is provided with an insertion hole into which the tool is inserted so as to operate the knocker by turning the tool.

According to an embodiment of the present invention, the synchronizing brake device for a vehicle is provided with the first brake, the second brake, the synchronizing brake operating lever that synchronizes and operates the first brake and the second brake, the equalizer that distributes the control force of the synchronizing brake operating lever to the first brake and the second brake, the hydraulic master cylinder that generates hydraulic pressure for operating the first brake and the first brake control force transmitting means which transmits control force from the equalizer to the hydraulic master cylinder and which is configured by the synchronizing member operated by the equalizer and the knocker that presses the hydraulic master cylinder by the operation of the synchronizing member.

As the knocker is provided with the knocker operating lever that can press the hydraulic master cylinder by being directly operated without depending upon the synchronizing member, the air bleeding of the hydraulic master cylinder can be easily executed and the time for air bleeding can be reduced.

According to an embodiment of the present invention, as the knocker is provided with the socket for the tool, the knocker can be operated via the tool.

According to an embodiment of the present invention, as the knocker presses the hydraulic master cylinder by being turned and the socket is provided with the insertion hole into which the tool is inserted so as to operate the knocker by turning the tool, operation force is reduced because the tool is inserted and is turned.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a side view showing a vehicle adopting a synchronizing brake device for a vehicle according to the invention;

FIG. 2 is a system diagram showing the synchronizing brake device for a vehicle according to the invention;

FIG. 3 is a perspective view showing a master cylinder unit of the synchronizing brake device for a vehicle shown in FIG. 2;

FIG. 4 is a plan showing the master cylinder unit shown in FIG. 3;

FIG. 5 is a front view showing the master cylinder unit shown in FIG. 3;

FIG. 6 is a side view showing the master cylinder unit shown in FIG. 3;

FIG. 7 is a sectional view viewed along a ling 7-7 shown in FIG. 5;

FIG. 8 is a front view showing a state in which an equalizer, a synchronizing turning lever and a knocker respectively of the master cylinder unit shown in FIG. 3 are combined;

FIGS. 9(a) to 9(c) are front views showing each of the equalizer, the synchronizing turning lever and the knocker respectively of the master cylinder unit shown in FIG. 3 in this order;

FIG. 10 is a first explanatory drawing showing the operation of the master cylinder unit shown in FIG. 3;

FIG. 11 is a second explanatory drawing showing the operation of the master cylinder unit shown in FIG. 3;

FIG. 12 is a third explanatory drawing showing the operation of the master cylinder unit shown in FIG. 3;

FIG. 13 is a fourth explanatory drawing showing the operation of the master cylinder unit shown in FIG. 3;

FIG. 14 is a fifth explanatory drawing showing the operation of the master cylinder unit shown in FIG. 3;

FIG. 15 shows another embodiment of the knocker of the master cylinder unit shown in FIG. 3;

FIG. 16 shows further another embodiment of the knocker of the master cylinder unit shown in FIG. 3;

FIG. 17 is a front view showing another embodiment of the master cylinder unit shown in FIG. 3;

FIG. 18 is a front view showing a knocker shown in FIG. 17;

FIG. 19 is an arrow view viewed from a direction shown by an arrow 19 in FIG. 18; and

FIG. 20 is an explanatory drawing for explaining the action of the knocker shown in FIG. 17.

### DETAILED DESCRIPTION OF THE PREFERRED EMBODIMENTS

Referring to attached drawings, a best mode for carrying out the present invention will be described below. The drawings shall be viewed in the direction of the reference numerals.

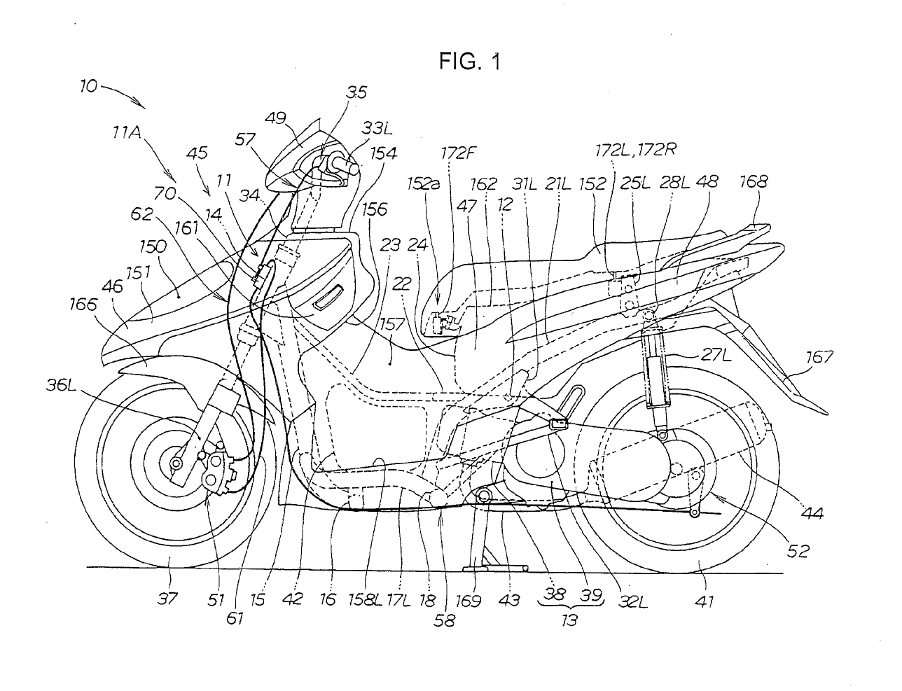

As illustrated in FIG. 1, a motorcycle 10 as a scooter-type vehicle is a so-called unit swing type vehicle provided with a body frame 11 and a power unit 13 vertically swingably attached to the body frame 11 via a pivot 12.

The body frame 11 primarily includes a head pipe 14 provided at a front end of the vehicle, a main frame 15 extending rearwardly and diagonally downward from the head pipe 14, a first cross frame 16 extending laterally and horizontally from a lower end of the main frame 15, left and right lower frames 17L, 17R (only the reference numeral 17L on this side is shown in FIG. 1) respectively extending rearwardly after each extends outwardly in a lateral direction from a lower part of the main frame 15 and is respectively supported by the first cross frame 16, a second cross frame 18 laid between rear ends of the left and right lower frames 17L, 17R, left and right rear frames 21L, 21R (only the reference numeral 21L on this side is shown in FIG. 1) raised rearwardly and diagonally upward from the lower frames 17L, 17R, extending up to the rear of the vehicle and also functioning a seat rail, a third cross frame 22 arranged in front from an intermediate part of each rear frame 21L, 21R substantially in a U-shape in a top view and laid between the rear frames 21L, 21R and a center pipe 23 that couples the main frame 15 and the third cross frame 22.

Housing box supporting brackets 25L, 25R (only the reference numeral 25L on this side is shown in FIG. 1) for attaching a housing box 24 described later are arranged in the rear of each rear frame 21L, 21R, and rear shock absorber bolts 28L, 28R (only the reference numeral 28L on this side is shown in FIG. 1) for attaching rear shock absorber units 27L, 27R (only the reference numeral 27L on this side is shown in FIG. 1) are arranged at the back of each housing box supporting bracket 25L, 25R. Pivot brackets 31L, 31R (only the reference numeral 31L on this side is shown in FIG. 1) including the pivot 12 for supporting the power unit 13 are provided to the rear frames 21L, 21R. Pillion step frames 32L, 32R (only 32L on this side is shown in FIG. 1) are provided for supporting each step for a pillion passenger.

A steering shaft 34 is steerably attached to the head pipe 14. Each steering handlebar 35 and each front fork 36L, 36R (only the reference numeral 36L on this side is shown in FIG. 1) are attached to the upside and the downside of the steering shaft 34. A front wheel 37 is turnably attached to a lower end of each front fork 36L, 36R.

The power unit 13 is configured by an engine 38 provided forward and substantially horizontally. A transmission unit 39 is attached to the rear of the engine 38 with a rear wheel 41 as a driving wheel being attached to a rear end of the transmission unit 39.

Each rear shock absorber unit 27L, 27R lies between the rear end of the transmission unit 39 and the intermediate part of each rear frame 21L, 21R.

A fuel tank 42 is arranged in an area surrounded by the main frame 15, the center pipe 23 and the lower frames 17L, 17R in front of the engine 38. An exhaust pipe 43 is connected to a lower part of the engine 38, extends rearwardly, and is connected to a muffler 44.

The body frame 11 is covered with a body cover 45, and a front body cover 46, an intermediate body cover 47 and a rear body cover 48 are arranged in that order from the front. A handlebar cover 49 is provided together with a headlight 150.

The front body cover 46 is configured by a front cover 151 forming the front of the vehicle with a front meter panel 154 arranged in front of a passenger's seat 152 as a cover member forming a rider's cab. A leg shield 156 is arranged and connecting with a lower end of the front meter panel 154 as an exterior cover for covering passenger's legs. A tunnel member 157 is arranged at the back of the leg shield 156 and is arranged between the rider's legs and step floors 158L, 158R (only the reference numeral 158L on this side is shown in FIG. 1) arranged on the left side and on the right side of the tunnel member 157 as a footrest for a rider.

A pocket 161 as a glove compartment is provided to the leg shield 156.

The housing box 24 having an opening 162 on the upside as a glove compartment is attached to the housing box supporting brackets 25L, 25R and the passenger's seat 152 is attached so as to openably cover the opening 162 of the housing box 24. The passenger's seat 152 enables the rider and a pillion passenger to be seated tandem and is integrated.

A front seating sensor 172F as a seating sensor for detecting the seating of the rider is arranged at a front end 152a of the passenger's seat 152. Central seating sensors 172L, 172R for detecting the seating of the rider are arranged in the vicinity of the center in a longitudinal direction of the passenger's seat 152. That is, plural seating sensors for detecting that the rider is seated are provided.

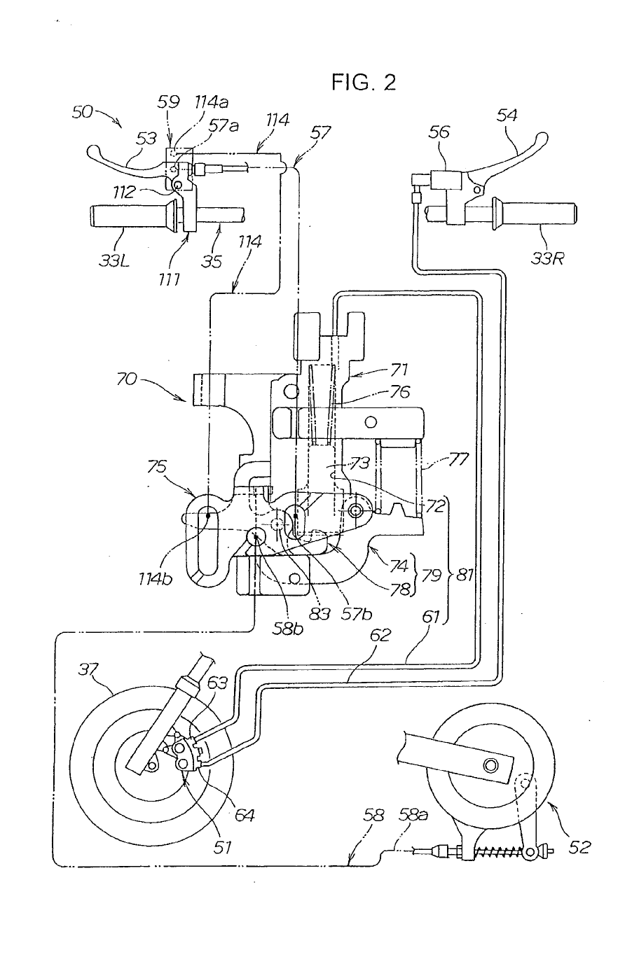

In FIG. 1, a body 11A is provided together with left and right grips 33L and 33R (as to 33R, see FIG. 2), a hydraulic brake 51, a front fender 166, a rear fender 167, a grab rail 168, and a main stand 169.

As shown in FIG. 2, a synchronizing brake device 50 for a vehicle is configured by the hydraulic brake (the first brake) 51 provided to the front wheel 37, a mechanical brake (a second brake) 52 provided to the rear wheel 41 (see FIG. 1), a synchronizing brake operating lever (a left brake lever) 53 provided to the steering handlebar 35 so as to operate the hydraulic brake 51 and the mechanical brake 52, an independent brake operating lever (a right brake lever) 54 provided to the steering handlebar 35 so as to operate the hydraulic brake 51, a master cylinder unit 70 provided between the hydraulic brake 51 and the mechanical brake 52 so as to selectively operate the hydraulic brake 51 and the mechanical brake 52, a master cylinder 56 on the side of the handlebar which is provided to the steering handlebar 35, which is operated by the independent brake operating lever 54 and which operates only the hydraulic brake 51, synchronizing brake control force transmitting means (wire on the side of the operating lever) 57 one end 57a of which is connected to the synchronizing brake operating lever 53 and the other end 57b of which is connected to the side of the master cylinder unit 70, mechanical brake control force transmitting means (wire on the side of the brake) 58 one end 58a of which is connected to the mechanical brake 52 and the other end 58b of which is connected to the side of the master cylinder unit 70, brake lock means 59 that holds the mechanical brake 52 in an operated condition independent of the synchronizing brake operating lever 53, a hydraulic pipe 61 on the side of the unit that connects the master cylinder unit 70 and the hydraulic brake 51 and a hydraulic pipe 62 on the side of the handlebar that connects the master cylinder 56 on the side of the handlebar and the hydraulic brake 51.

The synchronizing brake operating lever (the left brake lever) 53 is turnably attached to a handlebar holder 111 of the steering handlebar 35 via a supporting shaft 112 and one end 57a of the synchronizing brake control force transmitting means (the wire on the side of the operating lever) 57 is attached to the synchronizing brake operating lever 53.

The hydraulic brake 51 is provided with a first joint 63 to which the hydraulic pipe 61 on the side of the unit is connected and a second joint 64 to which the hydraulic pipe 62 on the side of the handlebar is connected. The first and second joints 63, 64 are an independent hydraulic system.

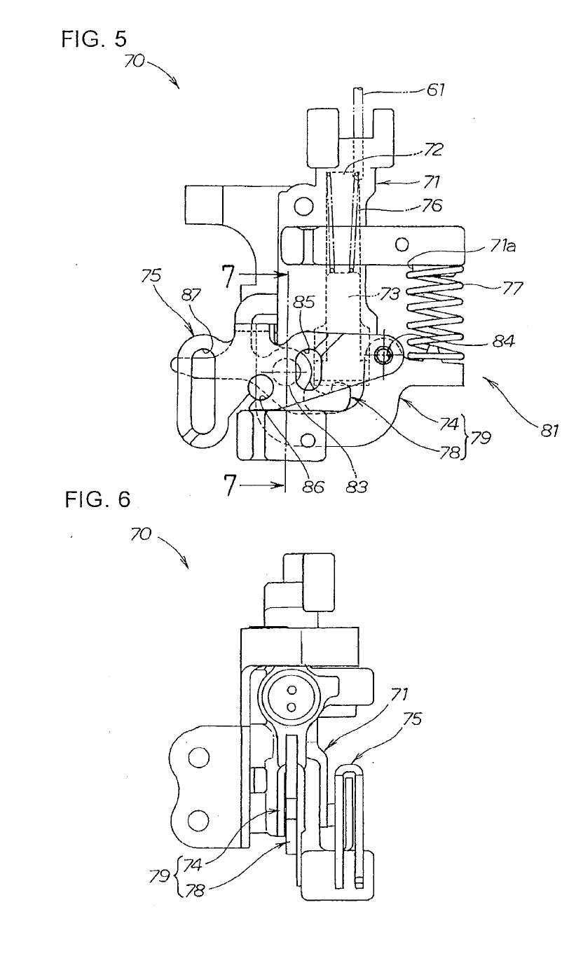

The brake lock means 59 is provided with a brake lock operating member (not shown) that operates a brake lock and brake lock control force transmitting means 114 one end 114a of which is connected to the brake lock operating member and the other end 114b of which is connected to a brake lock connecting part 87 of an equalizer 75 shown in FIG. 5.

Next, an outline of the operation of the synchronizing brake device 50 for a vehicle will be described.

First, oil is supplied to the hydraulic brake 51 from the master cylinder 56 on the side of the handlebar via the pipe 62 on the side of the handlebar by operating the independent brake operating lever 54, and the hydraulic brake 51 is converted to a condition in which the brake is turned on. As the synchronizing brake operating lever 53 is not operated, the master cylinder unit 70 remains an initial state and the mechanical brake 52 also remains in a condition wherein the brake is turned off.

Next, when the synchronizing brake operating lever 53 is operated, the synchronizing brake control force transmitting means (the wire on the side of the operating lever) 57 is pulled, the mechanical brake control force transmitting means (the wire on the side of the brake) 58 is pulled, and the mechanical brake 52 is converted to a weak braked condition.

Further, when the synchronizing brake operating lever 53 is operated, the synchronizing brake control force transmitting means (the wire on the side of the operating lever) 57 is further pulled, the hydraulic brake 51 is converted to the condition in which the brake is turned on, the mechanical brake control force transmitting means (the wire on the side of the brake) 58 is also further pulled, and the mechanical brake 52 is converted to a strongly braked condition.

In addition, the mechanical brake 52 can be held in an operated condition by operating the brake lock means 59.

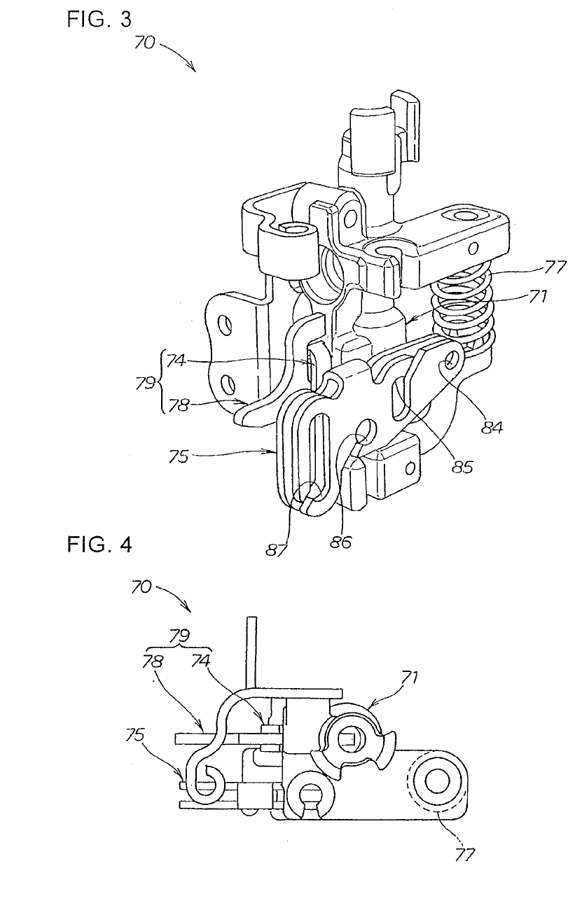

As shown in FIG. 3 to FIG. 7, the master cylinder unit 70 is configured by a cylinder block 71 as a body, a hydraulic master cylinder 72 provided in a vertical direction of the cylinder block 71, a lever mechanism (first brake control force transmitting means) 79 that drives a piston 73 of the hydraulic master cylinder 72, the equalizer 75 which is coupled to the lever mechanism 79 and which enables the hydraulic brake 51 and the mechanical brake 52 to be operated according to the operation of the synchronizing brake operating lever 53 (see FIG. 2) and a delay spring 77 which is provided between the cylinder block 71 and the lever mechanism 79, which delays the motion of the lever mechanism 79 and which resets the lever mechanism 79 to an initial condition. The hydraulic master cylinder 72 is provided with the slidable piston 73.

The cylinder block 71 is provided with a spring bracket 71a that bears one end of the delay spring 77. The piston 73 is provided with a return spring 76 pressed toward the downside of the hydraulic master cylinder 72.

Hydraulic brake control force transmitting means 81 is formed by the lever mechanism 79, the hydraulic master cylinder 72 and the hydraulic pipe 61 on the side of the unit.

The lever mechanism (the first brake control force transmitting means) 79 is configured by a synchronizing turning lever (a synchronizing member) 74 turnably attached to the cylinder block 71 via a shaft member 83 and a knocker 78 turnably attached coaxially with the synchronizing turning lever 74, that is, to the cylinder block 71 via the shaft member 83.

The shaft member 83 is a screw for fastening the synchronizing turning lever 74 and the knocker 78 to the cylinder block 71 coaxially and turnably as shown in FIG. 7.

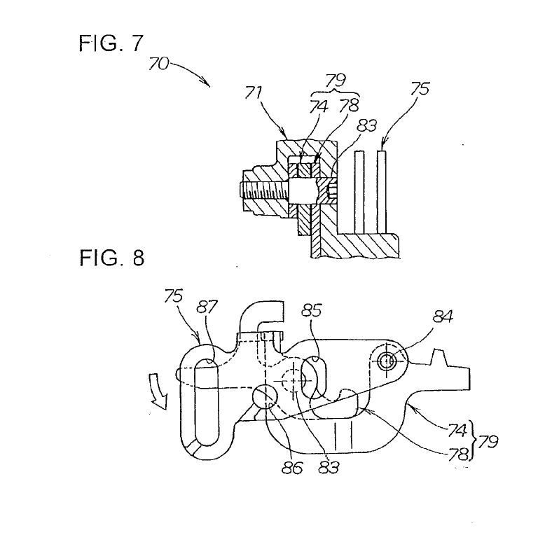

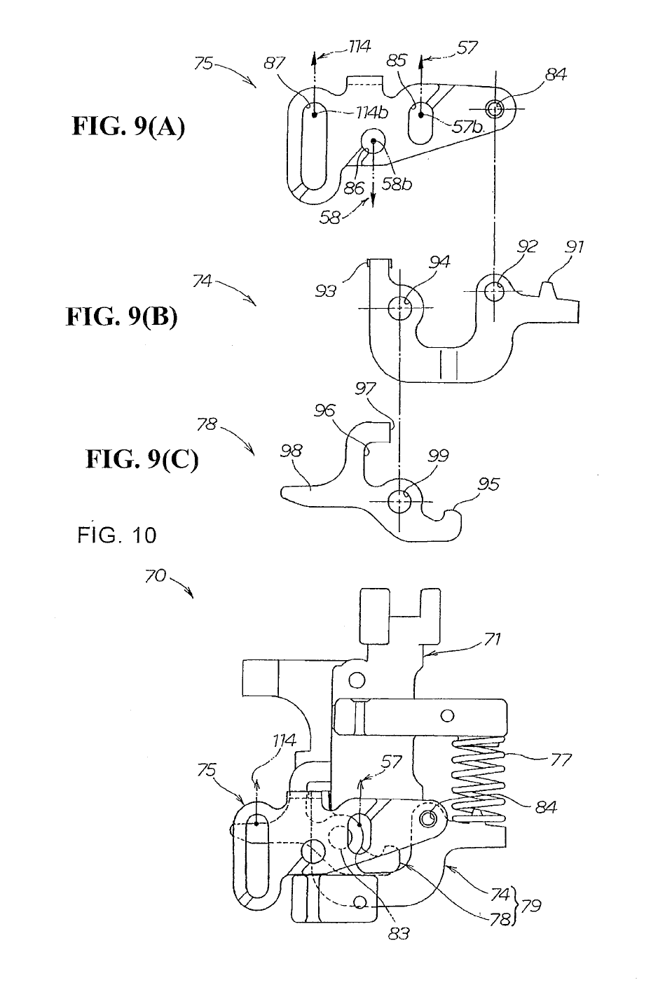

As shown in FIG. 8 and FIG. 9(a) to FIG. 9(c), in the equalizer 75, a hydraulic brake connecting part 84 for connecting the hydraulic brake control force transmitting means 81, a synchronizing brake connecting part 85 for connecting the other end 57b of the synchronizing brake control force transmitting means 57, a mechanical brake connecting part 86 for connecting the other end 58b of the mechanical brake control force transmitting means 58 and the brake lock connecting part 87 to which the other end 114b of the brake lock control force transmitting means 114 of the brake lock means 59 (see FIG. 2) is connected are formed in this order from the hydraulic brake connecting part 84, and the equalizer is turnably coupled to the synchronizing turning lever 74 using the hydraulic brake connecting part 84 as a fulcrum.

The synchronizing brake connecting part 85 and the brake lock connecting part 87 are formed in the shape of an elongate hole. It can be said that the brake lock connecting part 87 is formed outside the mechanical brake connecting part 86 of the equalizer 75.

More specifically, as the other end 57b of the synchronizing brake control force transmitting means 57 is slidably connected to the equalizer 75 and the other end 114b of the brake lock control force transmitting means 114 is slidably connected to the equalizer 75, a load can be prevented from being applied by the other control force transmitting means when either of the synchronizing brake control force transmitting means 57 or the brake lock control force transmitting means 114 is operated. As a result, the vain increase of control force can be avoided.

In the synchronizing turning lever 74, a spring bracket 91 that bears the other end of the delay spring 77, a coupling hole 92 to which the hydraulic brake connecting part 84 of the equalizer 75 is coupled, an application force transmitting part 93 that transmits application force to the knocker 78 and a shaft hole 94 turnably attached to the cylinder block 71 via the shaft member 83 shown in FIG. 7 are formed.

In the knocker 78, an operating part 95 that operates the piston 73 of the hydraulic master cylinder 72, a touching part 96 touched to the application force transmitting part 93 of the synchronizing turning lever 74, a stopper 97 touched to the cylinder block 71, a knocker operating lever 98 for air bleeding from a hydraulic circuit including the hydraulic master cylinder 72 and a shaft hole 99 turnably attached to the cylinder block 71 via the shaft member 83 shown in FIG. 7 are formed.

Further, as the knocker 78 has structure that the application force transmitting part 93 of the synchronizing turning lever 74 abuts on the touching part 96 and the stopper 97 abuts on the cylinder block 71 (see FIG. 5), the knocker 78 can be separately turned counterclockwise on page space as shown by an arrow the inside of which is void shown in FIG. 8.

Next, referring to FIGS. 10 to 14, the motion of the master cylinder unit 70 will be described.

FIG. 10 shows a state of the master cylinder unit 70 in an initial condition, and the synchronizing brake control force transmitting means 57 and the brake lock control force transmitting means 114 which are shown in FIG. 2 are not operated.

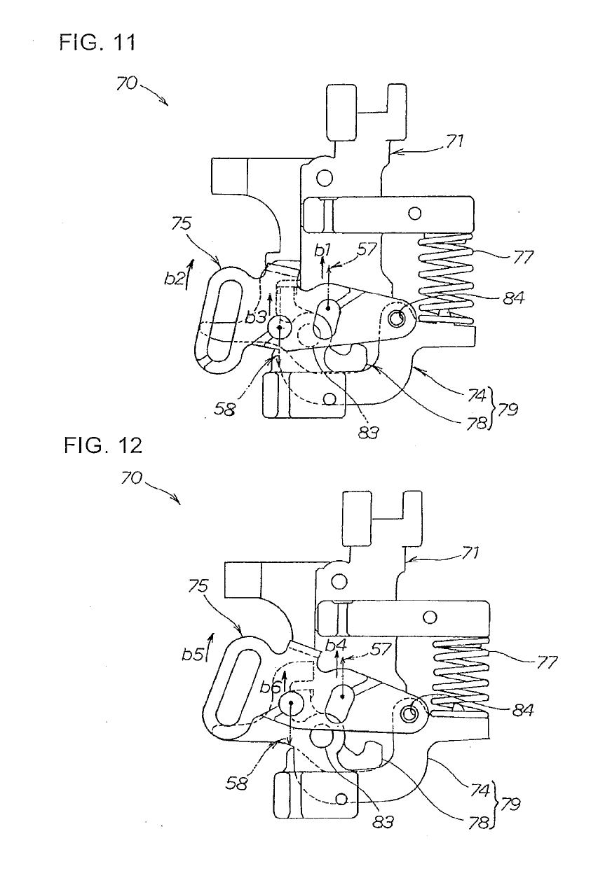

As shown in FIG. 11, when the synchronizing brake operating lever 53 shown in FIG. 2 is operated, the synchronizing brake control force transmitting means 57 is pulled as shown by an arrow b1, the equalizer 75 is turned with the hydraulic brake connecting part 84 in the center as shown by an arrow b2, the mechanical brake control force transmitting means 58 is pulled as shown by an arrow b3, and the mechanical brake 52 (see FIG. 2) is converted to the weak braked condition.

In this case, as the synchronizing turning lever 74 of the lever mechanism 79 is pressed by the delay spring 77, the initial condition can be maintained. As a result, as no oil is supplied to the hydraulic brake 51 shown in FIG. 2 from the hydraulic master cylinder 72, a condition in which the brake is turned off can be maintained.

As shown in FIG. 12, when the synchronizing brake operating lever 53 shown in FIG. 2 is further operated, the synchronizing brake control force transmitting means 57 is pulled as shown by an arrow b4, the equalizer 75 is turned with the hydraulic brake connecting part 84 in the center as shown by an arrow b5, the mechanical brake control force transmitting means 58 is pulled as shown by an arrow b6, and the mechanical brake 52 is converted to a strongly braked condition.

The master cylinder unit 70 operates the brake lock control force transmitting means 114 shown in FIG. 2, however, this condition is the same as a condition when the brake lock means 59 is operated. The synchronizing turning lever 74 and the knocker 78 of the lever mechanism 79 are kept in the initial condition.

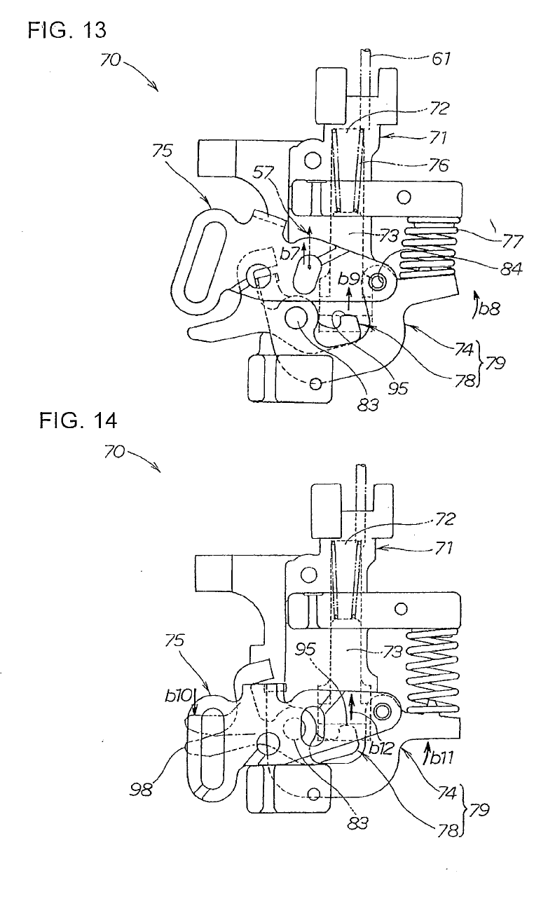

As shown in FIG. 13, when the synchronizing brake operating lever 53 is fully operated, the synchronizing brake control force transmitting means 57 is pulled as shown by an arrow b7, the equalizer 75 is moved substantially in parallel upward, the synchronizing turning lever 74 and the knocker 78 are turned as shown by an arrow b8 with the shaft member 83 in the center, the operating part 95 of the knocker 78 presses the piston 73 of the hydraulic master cylinder 72 as shown by an arrow b9, oil is supplied to the hydraulic brake 51 through the pipe 61 on the side of the unit, and the hydraulic brake 51 (see FIG. 2) is converted to the condition in which the brake is turned on.

As shown in FIG. 14, the knocker 78 can be separately turned with the shaft member 83 in the center as shown by an arrow b11 by pressing the knocker operating lever 98 of the knocker 78 as shown by an arrow 10, the operating part 95 of the knocker 78 presses the piston 73 of the hydraulic master cylinder 72 as shown by an arrow b12, and air in the whole hydraulic circuit can be bled including the air in the hydraulic master cylinder 72, the pipe 61 on the side of the unit and the hydraulic brake 51 (see FIG. 2).

More specifically, the knocker 78 is provided with the knocker operating lever 98 that can press the hydraulic master cylinder 72 by directly operating the knocker operating lever without depending upon the synchronizing member 74 in the synchronizing brake device 50 for a vehicle provided with the first brake 51, the second brake 52, the synchronizing brake operating lever 53 that synchronizes and operates the first brake 51 and the second brake 52, the equalizer 75 that distributes the control force of the synchronizing brake operating lever 53 to the first brake 51 and the second brake 52, the hydraulic master cylinder 72 that generates oil pressure for operating the first brake 51 and the first brake control force transmitting means (the lever mechanism) 79 configured by the synchronizing member (the synchronizing turning lever) 74 which transmits the control force from the equalizer 75 to the hydraulic master cylinder 72 and which is operated by the equalizer 75 and the knocker 78 that presses the hydraulic master cylinder 72 by the operation of the synchronizing member 74.

As the knocker operating lever 98 that can press the hydraulic master cylinder 72 by directly operating the knocker operating lever without depending upon the synchronizing member 74 is provided to the knocker 78, the air bleeding of the hydraulic master cylinder 72 can be facilitated and time required for air bleeding can be reduced.

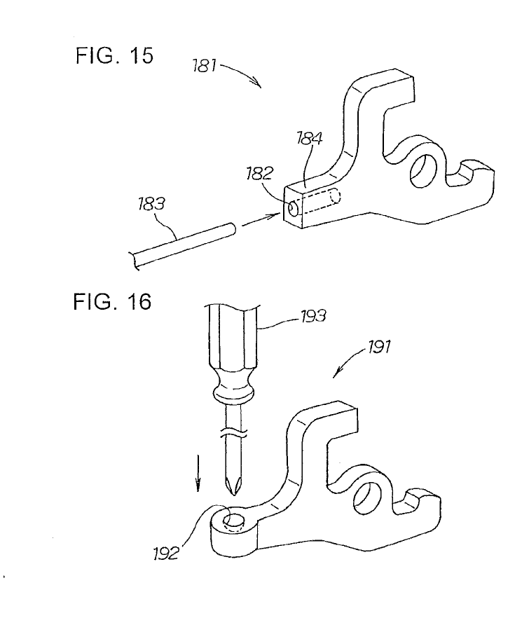

As shown in FIG. 15, in a knocker 181, an insertion hole 182 into which a tool (a rod) 183 for the air bleeding of a hydraulic master cylinder 72 is inserted is formed.

More specifically, as the knocker 181 presses the hydraulic master cylinder 72 by being turned and the insertion hole 182 for operating the knocker 181 by inserting the tool 183 and turning the tool 183 is provided to a socket 184, an operating load is reduced because the tool 183 has only to be inserted and turned.

As the insertion hole 182 into which the tool (the rod) 183 for the air bleeding of the hydraulic master cylinder is inserted is formed in the knocker 181, the knocker 181 can be formed in a compact shape and the layout of a master cylinder unit can be enhanced.

As shown in FIG. 16, in a knocker 191, a socket 192 is formed which receives an end of a screwdriver (a tool) 193 for the air bleeding of a hydraulic master cylinder.

As the socket 192 for the tool 193 is provided to the knocker 191, the knocker 191 can be operated via the tool 193.

More specifically, as the socket 192 that receives the end of the screwdriver 193 is formed for the air bleeding of the hydraulic master cylinder in the knocker 191, the air bleeding of the hydraulic master cylinder can be executed by the tool such as the screwdriver 193 and the maintainability of the master cylinder unit can be enhanced.

The knocker 191 can be operated from a remote position. As a result, another part can be arranged around the knocker 191 and a degree of freedom in design can be enhanced.

A master cylinder unit 200 in another embodiment in which the lever mechanism 79 of the master cylinder unit 70 shown in FIG. 5 is replaced with a lever mechanism 209 is a unit having the substantially same configuration as the master cylinder unit shown in FIG. 5.

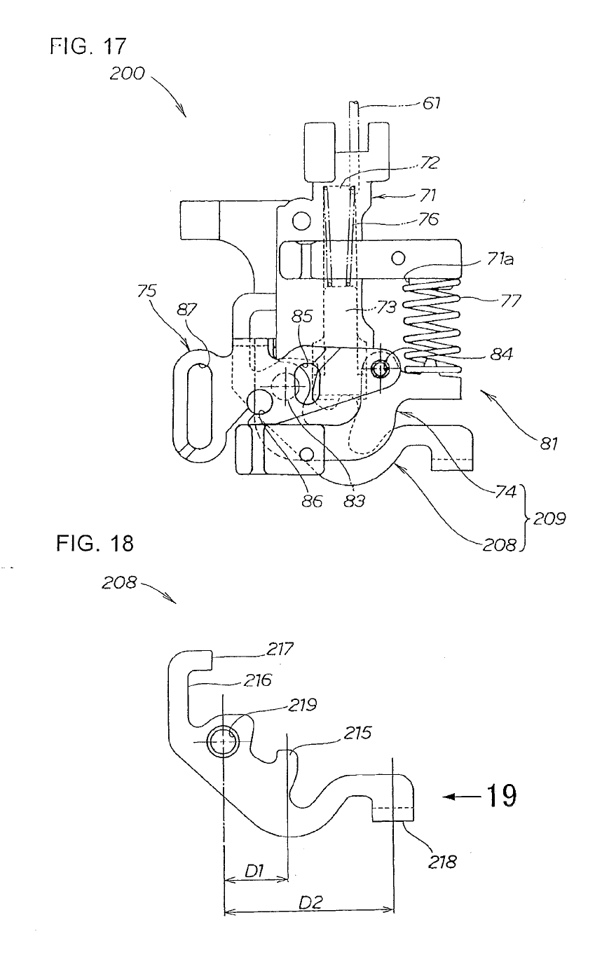

As shown in FIG. 17, the master cylinder unit 200 is configured by a cylinder block 71, a hydraulic master cylinder 72, the lever mechanism (the first brake control force transmitting means) 209 that drives a piston 73 of the hydraulic master cylinder 72, an equalizer 75 and a delay spring 77. The hydraulic master cylinder 72 is provided with the slidable piston 73.

The lever mechanism (the first brake control force transmitting means) 209 is configured by a synchronizing turning lever (a synchronizing member) 74 turnably attached to the cylinder block 71 via a shaft member 83 and a knocker 208 attached coaxially with the synchronizing turning lever 74, that is, turnably attached to the cylinder block 71 via the shaft member 83.

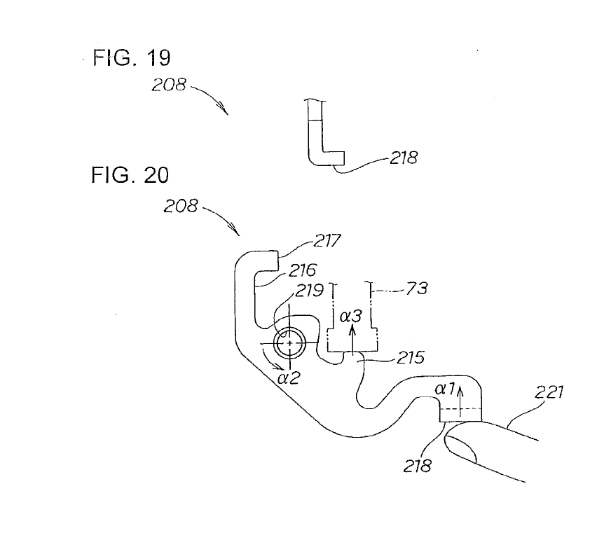

As shown in FIGS. 18 to 20, in the knocker 208, an operating part 215 that operates the piston 73 of the hydraulic master cylinder 72 (see FIG. 17), a touching part 216 which abuts on a control force transmitting part 93 of the synchronizing turning lever 74, a stopper 217 which abuts on the cylinder block 71, a knocker operating lever 218 that bleeds air in a hydraulic circuit including the hydraulic master cylinder 72 and a shaft hole 219 turnably attached to the cylinder block 71 via the shaft member 83 shown in FIG. 7 are formed.

In this embodiment the distance from the shaft hole (the fulcrum) 219 to be a turning supporting axis of the knocker 208 to the operating part (the pressure cone apex) 215 that operates the piston 73 is D1 and distance from the shaft hole (the fulcrum) 219 to the knocker operating lever (the point of the lever where force is applied) 218 is D2, D2>D1.

Further, in the knocker 208, when the distance D1 is fixed, the distance D2 can be extended to predetermined length outward. That is, as the point of the lever 218 can be separated from the fulcrum 219, the pressure can be reduced.

As shown in FIG. 20, when the knocker 208 is turned as shown by an arrow α2 with the shaft hole (the fulcrum) 219 in the center by softly pressing the knocker operating lever (the point of the lever) 218 with a finger 221 as shown by an arrow al and the piston 73 of the hydraulic master cylinder 72 is pressed as shown by an arrow α3, air in the whole hydraulic circuit including the hydraulic master cylinder 72, a pipe 61 on the side of the unit and a hydraulic brake 51 (see FIG. 2) can be bled.

In the synchronizing brake device for a vehicle according to the present invention, the insertion hole 182 is formed in the knocker 181 as shown in FIG. 15, however, the present invention is not limited to this case, and a tool in which a male screw is formed may be also inserted into a knocker 181 in which a female screw is formed.

In the synchronizing brake device for a vehicle according to the present invention, the knocker 191 is pressed by the screwdriver 193 as shown in FIG. 16, however, the present invention is not limited to this case, and wire and others installed on the socket 192 may be also pulled.

The synchronizing brake device for a vehicle according to the present invention is the synchronizing brake including the hydraulic brake and when only one brake operating lever that operates a hydraulic system is provided, the synchronizing brake device for a vehicle is suitable for various vehicles including a motorcycle and a four-wheeled vehicle.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A synchronizing brake device for a vehicle comprising:
a first brake;
a second brake;
a synchronizing brake operating lever for synchronizing and operates the first brake and the second brake;
an equalizer for distributing the control force of the synchronizing brake operating lever to the first brake and the second brake;
a hydraulic master cylinder for generating hydraulic pressure for operating the first brake; and
first brake control force transmitting means for transmitting a control force from the equalizer to the hydraulic master cylinder and which is configured by a synchronizing member operated by the equalizer and a knocker that presses the hydraulic master cylinder by the operation of the synchronizing member;
wherein the knocker is provided with a knocker operating lever that can press the hydraulic master cylinder by being directly operated without depending upon the synchronizing member.

2. The synchronizing brake device for a vehicle according to claim 1, wherein the knocker is provided with a socket for a tool.

3. The synchronizing brake device for a vehicle according to claim 2, wherein the knocker presses the hydraulic master cylinder by being turned; and
the socket is provided with an insertion hole into which the tool is inserted so as to operate the knocker by turning the tool.

4. The synchronizing brake device for a vehicle according to claim 1, wherein the synchronizing turning lever is turnably attached to a cylinder block by a shaft member and the knocker is turnably attached coaxially with the synchronizing turning lever.

5. The synchronizing brake device for a vehicle according to claim 1, and further including a brake connecting part for connecting the first brake control force transmitting means and the synchronizing member is a synchronizing turning lever wherein the equalizer is turnably coupled to the synchronizing turning lever using the brake connecting part.

6. The synchronizing brake device for a vehicle according to claim 5, wherein the equalizer includes a synchronizing brake connecting part and a brake lock connecting part each formed in the shape of an elongated hole.

7. The synchronizing brake device for a vehicle according to claim 5, wherein the synchronizing turning lever includes a spring bracket for mounting a delay spring, a coupling aperture for connecting the brake connecting part, an application force transmitting part for transmitting an application of force to the knocker and a shaft aperture turnably attached to a cylinder block via a shaft member.

8. The synchronizing brake device for a vehicle according to claim 7, wherein the knocker includes an operating part for operating on a piston of the hydraulic master cylinder, a touching part touched by the application force transmitting part of the of the synchronizing turning lever, a stopper touched to the cylinder block, a knocker operating lever for air bleeding of the hydraulic master cylinder and a shaft hole turnably attached to the cylinder block via the shaft.

9. The synchronizing brake device for a vehicle according to claim 8, wherein when the application force transmitting part of the synchronizing turning lever abuts on the touching part and the stopper abuts on the cylinder block, the knocker can be separately turned counterclockwise.

10. The synchronizing brake device for a vehicle according to claim 1, wherein by operating the brake operating lever the synchronizing brake control force transmitting means is actuated to turn the equalizer with a brake connecting part and a mechanical brake control force transmitting means is actuated to control the second brake.

11. A synchronizing brake device for a vehicle comprising:
a first brake;
a second brake;
a synchronizing brake operating lever for synchronizing and operates the first brake and the second brake;
an equalizer for distributing the control force of the synchronizing brake operating lever to the first brake and the second brake;
a hydraulic master cylinder for generating hydraulic pressure for operating the first brake;
a synchronizing member operated by the equalizer; and
a knocker for actuating the hydraulic master cylinder, said knocker being selectively operated by the synchronizing member, said knocker including an operating lever;
first brake control force transmitting means for transmitting a control force from the equalizer to the hydraulic master cylinder, said synchronizing member being operatively controlled by the equalizer and the knocker being selectively operatively controlled of the synchronizing member;
wherein the knocker operating lever can actuate the hydraulic master cylinder by a direct operation of the knocker operating lever without depending upon the synchronizing member.

12. The synchronizing brake device for a vehicle according to claim 11, wherein the knocker is provided with a socket for a tool.

13. The synchronizing brake device for a vehicle according to claim 12, wherein the knocker presses the hydraulic master cylinder by being turned; and
the socket is provided with an insertion hole into which the tool is inserted so as to operate the knocker by turning the tool.

14. The synchronizing brake device for a vehicle according to claim 11, wherein the synchronizing turning lever is turnably attached to a cylinder block by a shaft member and the knocker is turnably attached coaxially with the synchronizing turning lever.

15. The synchronizing brake device for a vehicle according to claim 11, and further including a brake connecting part for connecting the first brake control force transmitting means and the synchronizing member is a synchronizing turning lever wherein the equalizer is turnably coupled to the synchronizing turning lever using the brake connecting part.

16. The synchronizing brake device for a vehicle according to claim 15, wherein the equalizer includes a synchronizing brake connecting part and a brake lock connecting part each formed in the shape of an elongated hole.

17. The synchronizing brake device for a vehicle according to claim 15, wherein the synchronizing turning lever includes a spring bracket for mounting a delay spring, a coupling aperture for connecting the brake connecting part, an application force transmitting part for transmitting an application of force to the knocker and a shaft aperture turnably attached to a cylinder block via a shaft member.

18. The synchronizing brake device for a vehicle according to claim 17, wherein the knocker includes an operating part for operating on a piston of the hydraulic master cylinder, a touching part touched by the application force transmitting part of the of the synchronizing turning lever, a stopper touched to the cylinder block, a knocker operating lever for air bleeding of the hydraulic master cylinder and a shaft hole turnably attached to the cylinder block via the shaft.

19. The synchronizing brake device for a vehicle according to claim 18, wherein when the application force transmitting part of the synchronizing turning lever abuts on the touching part and the stopper abuts on the cylinder block, the knocker can be separately turned counterclockwise.

20. The synchronizing brake device for a vehicle according to claim 11, wherein by operating the brake operating lever the synchronizing brake control force transmitting means is actuated to turn the equalizer with a brake connecting part and a mechanical brake control force transmitting means is actuated to control the second brake.
